(19) United States
(12) Patent Application Publication
(10) Pub. No.: US 2003/0127058 A1
(43) Pub. Date: Jul. 10, 2003

(54) Collapsible animal container

(76) Inventors: William L. Sletten, Cologne, MN (US); Duane M. Smith, Mayer, MN (US)

Correspondence Address: RIDER, BENNETT, EGAN & ARUNDEL, 333 SOUTH SEVENTH STREET, SUITE 2000, MINNEAPOLIS, MN, 55402, US

(21) Appl. No.: 10/041,927

(22) Filed: Jan. 7, 2002

(51) Int. Cl. A01K 1/00; A01K 1/03

(52) U.S. Cl. 119/496

(57) ABSTRACT

A collapsible animal container (10) having a lightweight construction is disclosed. The animal container (10) is constructed of a flexible housing (12) suspended by rigid panels (14) separated by struts (16). The housing (12) includes a top wall, bottom wall, a pair of end walls and a pair of sidewalls. One or more struts (16) are provided and are biased between the rigid panels (14) to maintain the animal container (10) in an open and usable configuration. When removed, the struts (16) may be stored in pockets (20) formed in the sidewalls to simplify transport. A strap (36) and/or leash may also be provided to bundle the rigid panels (14) together when not in use or for transport. A handle (18) may also be incorporated into the animal container (10) or strap (36), particularly, to further simplify transport.

### BACKGROUND OF THE INVENTION

1. Field of the Invention

The present invention relates to animal containers and, more particularly, to animal containers that are portable and collapsible.

Description of the Related Art

A variety of animal containers are currently available. Generally, the containers are designed to be strong enough to confine an animal and light enough so that they can be easily handled. To make the containers even easier to handle, some containers are also collapsible. The collapsibility reduces the volume of the container making the container easier to store and transport.

The collapsible containers are available in a variety of configurations. Some collapsible containers have rigid hinged collapsible walls which give the appearance of a suitcase when folded. However, these containers tend to be heavy and overly complex. Their weight makes these containers cumbersome to handle and their complexity invites component failure and increases manufacturing costs. Still other containers have a rigid telescoping design that is typically less complicated than the hinged collapsible containers. However, the telescoping rigid containers typically do not collapse as efficiently as the hinged designs and, therefore, take up a substantial volume even when collapsed. Further, the telescoping rigid containers are still relatively heavy.

Other lighter weight containers have flexible housings supported by a collapsible internal aluminum framing. The aluminum framing is provided with hinges and hinged foldable cross braces to allow the structure's collapse. Although this hinged design is relatively light, the aluminum framing is complex and the plurality of hinges and cross-braces invite component failure. The complexity adds to the time for manufacture and decreases the acceptable tolerances during manufacture, thus increasing manufacturing costs. The hinging of components alone makes the framing more expensive to manufacture and invites component failure. The hinged cross-braces may also be difficult to bend into an unlocked configuration permitting collapse, frustrating a user. Further, the forces required to collapse the container can create excessive wear and fatigue components of the framing resulting in a housing that is not taut or even leading to component failure, either of which lead to increased customer dissatisfaction. The internal hinged aluminum frame design is also relatively expensive to design and manufacture. Therefore, a need exists for a container having a strong, lightweight and simple construction allowing for efficient manufacture.

In addition, portable animal containers are frequently transported adjacent the rear hatch in sport utility vehicles. The hatch on sport utility vehicles typically has an angle to the floor of less than 90 degrees and, typically, the ends of animal containers are perpendicular to the floor. Therefore, a space is created between the animal container and the door when the top of the animal container abuts the hatch. This loss of space is amplified when transporting multiple containers. Therefore, a need exists for a container which has one or more angled ends to conform to the angle of the rear hatch and provide the maximum possible interior space for the animal within the container while most effectively utilizing the space available within a sport utility vehicle or other automobile.

The present invention meets the above needs and provides additional improvements and advantages that will be recognized by those skilled in the art upon review of the following specification and figures.

### SUMMARY OF THE INVENTION

The present invention provides a lightweight animal container that can easily be collapsed to a reduced size. The rigid sidewalls supporting the housing increase the strength and durability of the design. The present invention also provides a design with one or more angled walls to conform to the rear hatch or rear seatbacks of a vehicle. Further, the present invention can provide a storage pocket for holding struts and other items, and can include various windows or openings to allow ventilation and/or access to the animal.

In one aspect of the present invention, the invention is a collapsible animal container comprising a housing, a pair of opposing rigid panels and at least one strut. The housing is formed, at least in part, of flexible material and includes a top wall, a bottom wall, a pair of end walls, and a pair of sidewalls. The housing can include one or more windows in one or more of the sidewalls and/or the end wall. The windows can be made of a mesh material, a clear plastic or other material that will be recognized by those skilled in the art. Further, the flexible collapsible animal container may include a door in one of the end walls and/or sidewalls. The door can be made of a mesh material. A pair of opposing rigid panels may be positioned within or are integral with the housing or, alternatively, a pair of peripheral frames may be positioned within or are integral with the housing. The rigid panels are collapsible toward one another and are maintained in a separated position by the at least one strut to support the housing. The rigid panels may be integral with the housing. Alternatively, the pair of rigid panels can function as the pair of sidewalls, the pair of end walls, or the combination of top wall and bottom wall. The struts can be a releasable strut and a collapsible strut. The struts can include a rod having an end cap secured to the rod at a first end of the rod and a hinge secured to the rod at a second end of the rod, the hinge attached to at least one of a rigid panel and a wall to allow the rod to pivot. The end cap can be a rubber cap, telescoping end cap or a extendable threaded end cap. One or more strut braces can be provided and secured to the housing to secure the strut. The struts can include a rod having end caps secured to each end of the rod. The rod may be a spring-loaded telescoping rod. The end cap can be a telescoping end cap or a extendable threaded end cap.

In another aspect of the invention, the collapsible animal container may have at least one sidewall or end wall at an acute angle to the bottom wall.

### BRIEF DESCRIPTION OF THE DRAWINGS

FIG. 1 illustrates a perspective view of an end of an embodiment of an animal container in accordance with the present invention in an open configuration;

FIG. 2 illustrates a perspective view of the other end of the embodiment of the animal container of FIG. 1 including a door and showing the internal placement of the struts;

FIG. 3 illustrates an exploded perspective view of another embodiment of an animal carrier in accordance with the present invention.

FIG. 4 illustrates a perspective view of the embodiment of the animal container of FIGS. 1 and 2 in a collapsed configuration;

FIG. 5 illustrates a partial cross-section of an embodiment of a sidewall including a rigid panel;

FIG. 6 illustrates an embodiment of a strut;

FIG. 7 illustrates an embodiment of a strut having a hinge;

FIG. 8 illustrates an embodiment of a strut brace and a strut; and

FIG. 9 illustrates an embodiment of an animal container in accordance with the present invention fitted within a vehicle.

### DETAILED DESCRIPTION OF THE INVENTION

The present invention is generally described in the context of the embodiments shown in the figures. The appended claims are not intended to be limited to these embodiments. That is, the described embodiments are considered in all respects as illustrative, not restrictive. The present invention may be embodied in other specifications and may be otherwise altered without departing from the scope of the appended claims. Further, in the drawings described below, the reference numerals are generally repeated where identical elements or analogous elements appear in more than one figure.

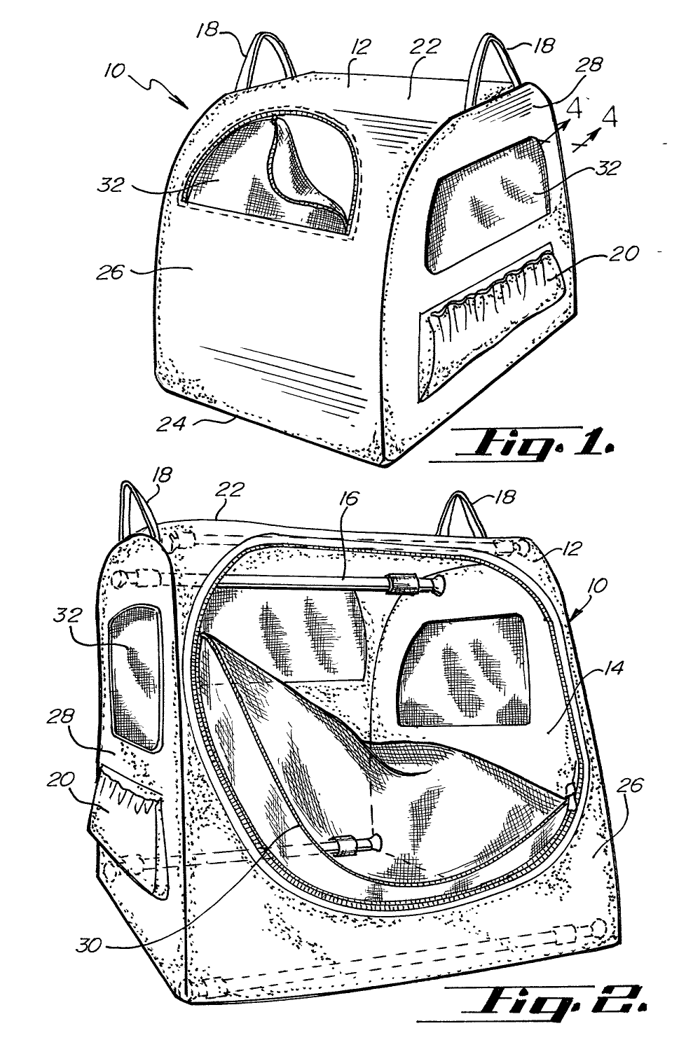

FIGS. 1, 2 and 3 illustrate embodiments of an animal container 10 in accordance with the present invention. Animal container 10 includes a housing 12, a pair of opposing support elements 14, and one or more struts 16. Housing 12 is, at least in part, constructed of a flexible material. Opposing support elements 14, at least in part, support housing 12 by being positioned adjacent opposing walls within housing 12 and biased apart and against housing 12 with one or more struts 16.

Housing 12 generally includes a top wall 22, a bottom wall 24, a pair of end walls 26 and a pair of sidewalls 28 configured to confine an animal. The walls are shaped so that when joined to form housing 12, the shape of housing 12 allows the housing to confine an animal. The trapezoidal shape of housing 12 generally illustrated throughout the figures is shown for exemplary purposes only. Housing 12 is, at least in part, constructed of a flexible material to permit the collapse of animal container 10. The material of housing 12 can be a flexible plastic, a nylon or other synthetic fabric, cotton or other natural fiber fabric, or other material that will be recognized by those skilled in the art. Housing 12 can be formed from the material by securing adjacent walls at their edges by stitching, welding or by other method that will be recognized by those skilled in the art or the adjacent walls may be formed from a continuous piece of material. In one form, housing 12 is constructed to allow opposing walls including support elements 14 to collapse toward on another when struts 16 are removed.

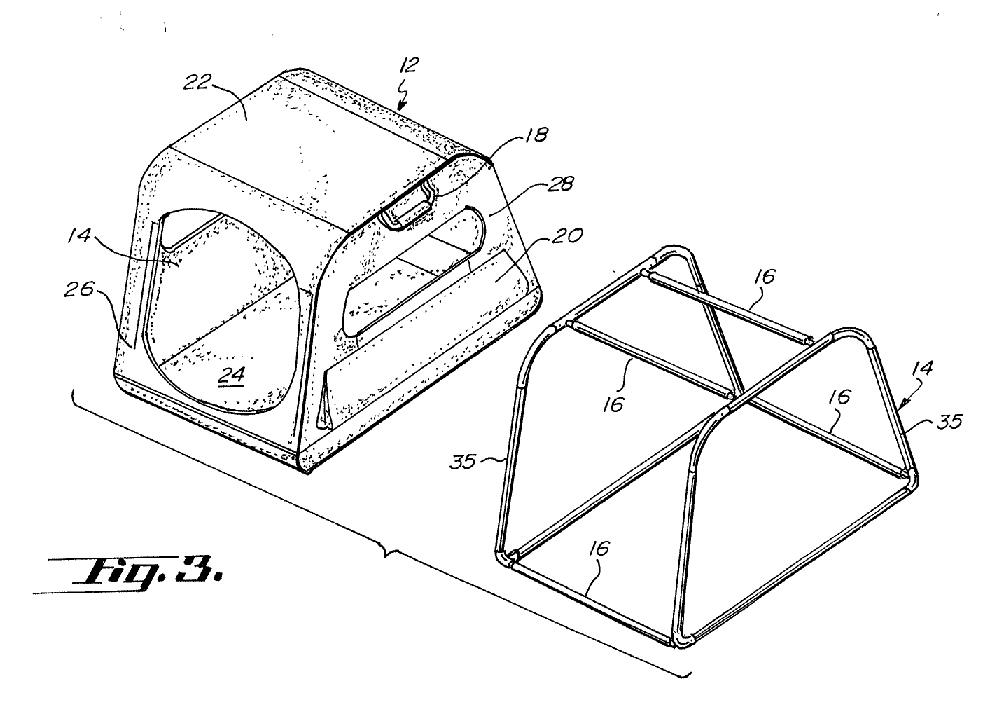

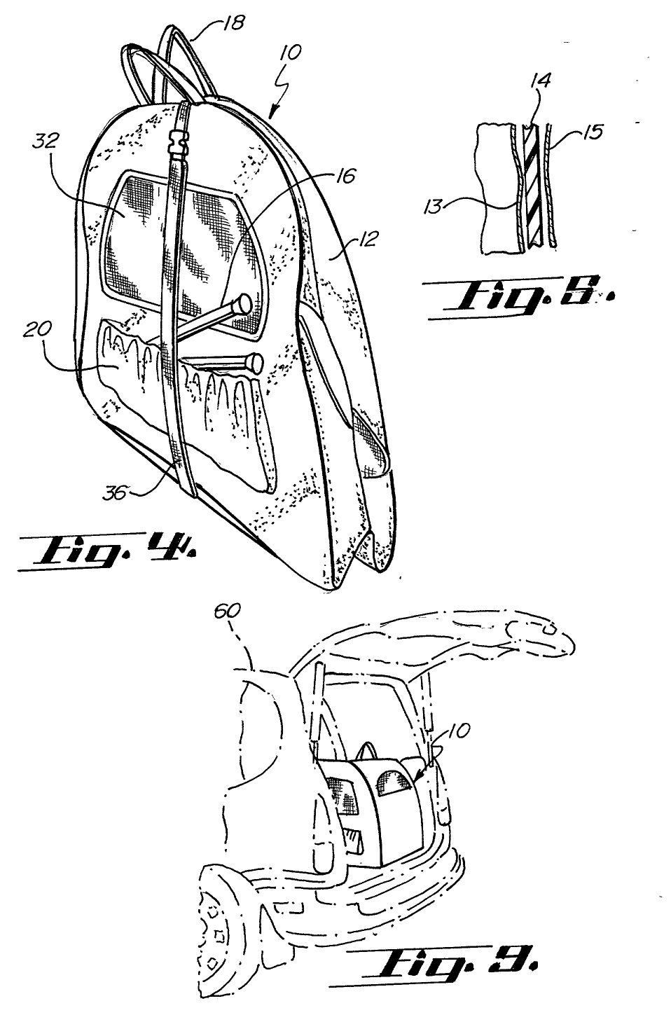

Support elements 14 may be a panel 25, as shown in FIGS. 2 and 5, may be a peripheral frame 35, as shown in FIG. 3, or may be in another form designed to support opposing walls of housing 12 when biased against the opposing walls with struts 16. Generally, support elements 14 are shaped to support the walls which support elements 14 abut. In one form, support element 14 has the same peripheral shape as the wall which the particular support element abuts. That is, for example, if the wall against which support element 14 is place is a trapezoid, then support element 14 is shaped as a trapezoid, or if the wall against which support element 14 is place is a square, then support element 14 is shaped as a square.

Opposing support elements 14 can simply be positioned within housing 12, can be secured adjacent to a wall within housing 12, can be integral with a wall of housing 12, or can be integral with the material of housing 12. FIG. 5 illustrates support element 14 in the form of panel 25 integral within a wall of housing 12. In the embodiment of FIG. 5, support element 14, shown as panel 25 for exemplary purposes, is secured between an inner layer of flexible material 13 and outer layer of flexible material 15 of a sidewall 28 having multiple layers for exemplary purposes. In other embodiments, the corners of support element 14 can be held in position by interior pockets formed in the corresponding corners of the particular wall that the support element is configured to abut or can be held in position by hook and loop type fasteners within housing 12. Alternatively, support elements 14 may be simply positioned adjacent the top wall and bottom wall, sidewalls, or end walls; may be integral with the top wall and bottom wall, sidewalls, or end walls in a manner other than that shown in FIG. 5; or may, when in the form of panels 25, themselves function as the top wall and bottom wall, sidewalls, or end walls of housing 12.

Panels 25 are typically constructed from a lightweight rigid material, such as nylon, aluminum, plastic, carbon fiber, wood, fiber board or other rigid materials which will be recognized by those skilled in the art upon review of the present disclosure. As generally discussed above, panels 25 are generally shaped to conform to the wall against which each panel 25 is positioned including possible cutouts for windows and doors. The cutouts for windows and doors aligning with the analogous structures on housing 12.

Peripheral frames 35 are typically constructed of tubes, bars or other elements that may be constructed into a frame. The elements of peripheral frame 35 are typically formed from lightweight rigid material. These materials can include aluminum, nylon, plastic, carbon fiber, wood or other rigid materials or structures which will be recognized by those skilled in the art upon review of the present disclosure. As generally discussed above, frames 35 are generally shaped to conform to the wall against which each frame 35 is positioned.

Support elements 14 are maintained in a separated position within the housing by one or more struts 16. Struts 16 are biased between support elements 14 to pull the flexible material of the housing 12 taut and, thereby, at least in part, support the housing. Struts 16 may function only to maintain the separation of rigid panels 14 or may themselves supplement the supporting function of support elements 14 by being positioned adjacent a wall of housing 12 that does not include a support element 14. Struts 16 are typically biased between opposing support elements 14 such that the longitudinal axis of strut 16 is parallel to the plane of the adjacent wall or, when positioned in a corner, planes of the two adjacent walls.

Struts 16, as shown in FIGS. 2, 3, 4, 6, 7, and 8, typically comprise a rod 42 having end caps 44 on each end. One or both of end caps 44 may be attached to the rod with a threaded design, spring-loaded design, or other design to allow the adjustment of the length of the strut. The adjustable length better facilitates insertion and removal of strut 16 within housing 12, and compensates for the stretching of the housing material over time and subtle variations in size inherent in the manufacture of both struts 16 and housing 12.

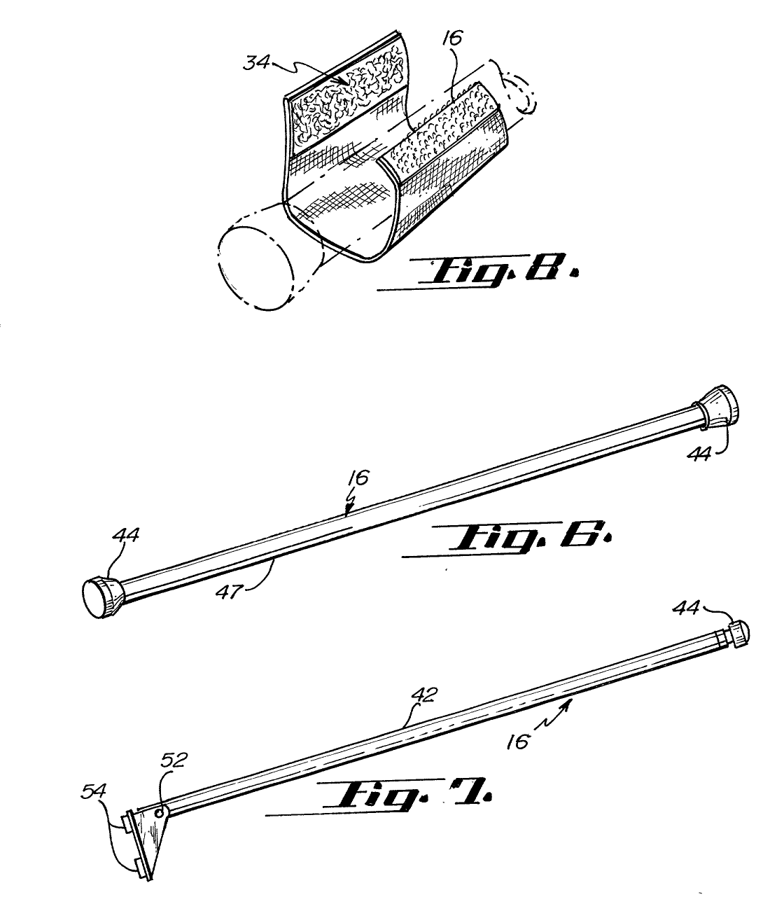

End caps 44 may be formed in various configurations depending on the nature and configuration of the support element 14 that the end caps 44 contact. End caps 44 may be positioned on one or both ends of rod 42 and may be threadedly attached to rod 42 to permit adjustment of the length of strut 16, as shown in FIG. 7. End caps 44 are typically formed from compressible elastic materials, such as rubber for example. When contacting a support element 14 in the form of a panel 25, end caps 44 are typically configured to provide a flat contact point to maximize the contact area with the generally flat panel 25. Alternatively, end caps 44 for contact with panels 25 may be configured in any of a variety of forms, such as having pointed end or rounded ends for example, to maximize the securing function of end cap 44 and/or to most easily permit the placement of strut 16 at the desired location within housing 12. When contacting a support element 14 in the form of a peripheral frame 35, end caps 44 are generally configured to maintain strut 16 on peripheral frame 35. In one exemplary form, end cap 44 may have a conical tip to fit within a depression or hole within peripheral frame 35 such that strut 16 is compressionally secured at a position on peripheral frame 35. In another exemplary form, end cap 44 may have a groove shaped end to receive an interior portion of peripheral frame 35 such that strut 16 is compressionally secured to peripheral frame 35. In yet another exemplary form, end cap 44 may be constructed of a resilient material, such as for example nylon, in the form of a C-shaped fitting. The C-shaped fitting is compressionally secured or “snapped” over peripheral frame 35 to secure strut 16 to peripheral frame 35. The C-shaped fitting is further configured to allow strut 16 to exert a force to bias opposing peripheral frames 35 against their respective walls within housing 12.

When using a rigid rod 42, end caps 44 are compressed and/or rigid rod 42 is flexed to position struts 16 between support elements 14 to maintain housing 12 in an open position. In another form, struts 16 may be of a telescoping design being maintained in an extended position by a spring or other resilient element. When of a telescoping design, strut 16 is compressed to reduce the length of strut 16 to permit the strut to be positioned between the rigid panels. Strut 16 is then released to bias opposing support elements 14 apart. In yet another form, a strut 16, as shown in FIG. 7, may be pivotally fastened to one of the rigid panels 14. A hinge 52 allows strut 16 be positioned parallel to the rigid panel 14 and/or wall to which hinge 52 is attached so that support elements 14 may be brought together and the housing 12 collapsed or positioned perpendicular to support elements 14 and/or wall of housing 12 to which hinge 52 is attached so that strut 16 and/or end cap 44 is biased against the opposing rigid panel 14. As shown in FIG. 7, hinge 52 can be removably attached to the wall and/or support element 14 such as by snap-type fasteners 54 or other releasable fasteners as will be recognized by those skilled in the art. In yet other forms, struts 16 may be flexible, releasable or collapsible to better facilitate installation and removal of strut 16 as will be recognized by those skilled in the art upon review of this disclosure.

One or more strut braces 34, as shown in FIGS. 2 and 8, may also be provided to further secure struts 16 at a desired location between support element 14. Strut braces 34 may include a hook and loop type fastener, buttons, snaps, straps for tying, or other brace that will be recognized by those skilled in the art upon review of this disclosure. With struts 16 installed, as shown in FIGS. 1 and 2, opposing support element 14 support housing 12 in an open configuration. Further, end walls 26 and/or sidewalls 28 may be configured so that in an open configuration the end walls or sidewalls may be at an acute angle to bottom wall 24. The acute angle allows animal container 10 to better conform to the interior walls of a vehicle transporting the container. With struts removed, as shown in FIG. 4, rigid panels 14 may be brought together to allow the top wall, bottom wall, and the pair of end panels to collapse. In the collapsed configuration, animal container 10 takes up less volume than in the open configuration.

To facilitate introduction and removal of the animal, housing 10 is typically provided with a door 30. Door 30 may be permanently or removably attached to housing 12. Door 30 is typically constructed of a woven mesh material to allow the ventilation of animal container 10 and observation of an animal within the container. Alternatively, door 30 may be constructed of a solid clear or opaque material. In addition, animal container 10 may be provided with one or more windows 32. Windows 32 can also be either permanently or removably attached to housing 12. Windows 32 allow for better observation of the interior of the container and allow for cross-ventilation of the container. Thus, windows 32 are also typically constructed of a woven mesh material. Alternatively, windows 32 may be constructed of a solid clear or opaque material. Door 30 and windows 32 may be provided with a snap, strap, zipper, peelable fastener or other fastener to permit door 30 and/or windows 32 in an open configuration or, alternatively, to be secured in a closed configuration.

Housing 12 can be provided with a set of feet and or legs on the bottom surface to prevent animal container 10 from sliding on the surface on which the animal container is placed. In addition, housing 12 may also be provided with one or more handles 18 to provide a convenient point to hold for the container in either or both of the open and collapsed configurations. One or more storage elements 20, such as pockets or sleeves, may also be provided on a wall of the container 10. Storage element 20 is shown as a pocket on sidewall 28 for exemplary purposes only. Storage element 20 may be used for the hold struts 16 when the animal container is in the collapsed position, as shown in FIG. 4. A strap 36 may also be provided to secure the rigid walls adjacent one another for storage and transport in the collapsed configuration. In one embodiment, strap 36 can also function as a leash.

FIG. 9 shows an exemplary placement of an animal container 10 within the cargo area of a vehicle 60. In use, animal container 10 may be positioned within the cargo area of vehicle 60. With animal container 10 in an open configuration, an animal is inserted into the container through door 30. Door 30 is then secured and the hatch to the vehicle is closed. During transport either windows 32 or door 30 may be used to gain access to the animal for providing food or water and for removing waste.

What is claimed is:

1. A collapsible animal container, comprising:
(a) a flexible material housing comprising a top wall, a bottom wall, a pair of end walls, and a pair of sidewalls;
(b) a pair of support members in the housing, with each support member positioned adjacent an opposing wall of the housing, and each support member having a peripheral shape substantially corresponding to the opposing walls of the housing against which each support member is positioned; and
(c) at least one strut secured between the support members to maintain the opposing support members in a separated position and to support the housing.

2. A flexible collapsible animal container, as in claim 1, with the support member comprising a rigid panel.

3. A flexible collapsible animal container, as in claim 1, with the support member comprising a peripheral frame.

4. A flexible collapsible animal container, as in claim 1, further comprising a door in at least one of the end walls and the sidewalls.

5. A collapsible animal container, as in claim 2, with the door comprising a mesh material.

6. A collapsible animal container, as in claim 1, further comprising at least one window in at least one of the sidewalls and the end walls.

7. A collapsible animal container, as in claim 6, with the at least one window comprising a mesh material.

8. A collapsible animal container, as in claim 1, wherein the rigid panels are integral with the housing.

9. A collapsible animal container, as in claim 1, the sidewalls comprising the pair of rigid panels.

10. A collapsible animal container, as in claim 1, the end walls comprising the pair of rigid panels.

11. A collapsible animal container, as in claim 1, the top wall and the bottom wall comprising the pair of rigid panels.

12. A collapsible animal container, as in claim 1, further comprising at least one of the sidewalls and the bottom walls are acutely angled to the bottom wall.

13. A flexible collapsible animal container, as in claim 1, with the at least one strut comprising a rod having end caps secured to each end of the rod.

14. A collapsible animal container, as in claim 13, the rod comprising a telescoping rod.

15. A collapsible animal container, as in claim 13, with the at least one end cap comprising a telescoping end cap.

16. A collapsible animal container, as in claim 13, at least one end cap comprising a extendable threaded end cap.

17. A collapsible animal container, as in claim 1, the at least one strut comprising a rod having end cap secured to the rod at a first end of the rod and a hinge secured to the rod at a second end of the rod, the hinge attached to at least one of a rigid panel and a wall to allow the rod to pivot.

18. A collapsible animal container, as in claim 17, the end cap comprising a telescoping end cap.

19. A collapsible animal container, as in claim 17, the end cap comprising a extendable threaded end cap.

20. A collapsible animal container, as in claim 1, further comprising at least one strut brace secured to the housing to secure the strut.

21. A collapsible animal container, as in claim 20, the strut brace comprising a peelable fastener.

22. A collapsible animal container, comprising
a means for housing an animal;
a means for supporting the means for housing; and
a means for separating the means for supporting.

23. A method for transporting an animal, comprising the steps of:
providing a collapsible animal container, comprising a flexible material housing comprising a floor, a ceiling and opposing sidewalls with a closable opening for access in at least one of the sidewalls, a pair of rigid panels within the housing, the rigid panels being collapsible toward one another, and at least one struts between the rigid panels supporting the housing;
placing the flexible collapsible animal container within a vehicle; and
placing an animal within the flexible collapsible animal container.
